(19) United States
(12) Patent Application Publication
(10) Pub. No.: US 2004/0219283 A1
(43) Pub. Date: Nov. 4, 2004

(54) Liquid retention of meat during cooking using trehalose

(76) Inventor: Jeffrey C. Evans, St. Michael, MN (US)

Correspondence Address: CARGILL, INCORPORATED, LAW/24, 15407 MCGINTY ROAD WEST, WAYZATA, MN, 55391, US

(21) Appl. No.: 10/835,920

(22) Filed: Apr. 30, 2004

Related U.S. Application Data
(60) Provisional application No. 60/467,041, filed on May 1, 2003.

(51) Int. Cl. A23L 1/20

(52) U.S. Cl. 426/641

(57) ABSTRACT

The invention provides improved methods using trehalose for preparing and cooking meat. More particularly, it provides for the addition of trehalose to uncooked meat to obtain decreased shrinkage during cooking. In addition, it provides for the addition of trehalose to increase the meat's liquid retention during cooking. Specific benefits include the ability to increase the meat's water retention and fat retention during cooking. The invention provides certain levels of trehalose concentration. It also provides certain combinations of trehalose, salt, and sodium phosphate. Furthermore, it provides for trehalose usage without the addition of starch.

### CROSS-REFERENCE TO RELATED APPLICATIONS

This application claims the benefit of U.S. Provisional Application No. 60/467,041, filed May 1, 2003.

### FIELD OF INVENTION

The invention relates to methods of using trehalose for preparing and cooking beef. More particularly, the invention relates to methods of using trehalose for preparing and cooking beef to increase the cooked yield of beef.

### BACKGROUND

Raw meat comprises a significant amount of liquid. For example, it comprises about 75% water, in addition to other components (such as fat), which become liquid during cooking. Meat contains such a high amount of liquid, that the loss of liquid is an ongoing problem for the meat industry. Typically, during refrigeration, meat may lose 1% to 3% of its total weight. Such loss is commonly called weep. The frozen meat may then lose 3% to 7% of its weight as drip upon thawing. Even more significantly, cooked meat may lose 30% to 40% of its weight as shrink during the cooking process.

The meat industry has relied heavily on certain additives, such as sodium chloride, sodium phosphate, lactate salts, vegetable proteins, and starches to reduce the loss of liquid during cooking. Examples of product categories where such additives are used include: beef patties, restructured meat, injected whole muscle meat, and cured meat. However, in spite of such additives, the loss of liquid during cooking remains a problem.

Thus there is a need in the meat industry for improved methods for the retention of liquids such as water and fat during cooking. There is also a need in the meat industry to have improved methods for the reduction of shrinkage of meat during cooking.

### SUMMARY

The invention relates to methods of preparing beef using trehalose to increase the cooked yield of the beef. The invention also relates to trehalose-containing beef products, which beef products exhibit increased cooked yield as compared to similar beef products without trehalose. Without being bound by theory, it is believed that addition of trehalose to uncooked beef can result in decreased shrinkage during cooking. It is also believed that the addition of trehalose to uncooked beef can increase the beef's liquid retention during cooking. Further, it is also believed that addition of trehalose to uncooked beef can increase the beef's water retention during cooking. Even further, it is also believed that the addition of trehalose to uncooked beef can increase the beef's fat retention during cooking.

Accordingly, one aspect of the invention relates to a method for increasing the cooked yield of beef. The method comprises: (1) adding trehalose to substantially uncooked beef; wherein the trehalose is distributed substantially throughout the beef; and wherein the weight of the trehalose is less than about 5% of the weight of the beef; and (2) cooking the beef. In another aspect of the invention, sodium phosphate is also added to the substantially uncooked beef; wherein the trehalose and the sodium phosphate are distributed substantially throughout the meat. In another aspect of the invention, the beef contains substantially no starch. In another aspect of the invention the amount of trehalose added is sufficient to decrease the shrinkage of beef during cooking, as compared to beef without added trehalose. In another aspect of the invention, trehalose is added in an amount sufficient to increase the capability of beef to retain water under cooking conditions, as compared to beef without added trehalose. In another aspect of the invention, trehalose is added in an amount sufficient to increase the capability of beef to retain fat under cooking conditions, as compared to beef without added trehalose. In another aspect of the invention, trehalose is added to beef in an amount sufficient to increase the capability of beef to retain liquid under cooking conditions, as compared to beef without added trehalose.

Another aspect of the invention relates to the application of various methods herein to comminuted beef, restructured beef, and whole beef muscle. A further aspect of the invention relates to beef, with reduced shrinkage during cooking as compared to beef without trehalose, prepared by various methods described herein. A further aspect of the invention relates to beef, with increased capability to retain water under cooking conditions as compared to beef without trehalose, prepared by various methods described herein. An even further aspect of the invention relates to beef, with increased capability to retain fat under cooking conditions as compared to beef without trehalose, prepared by various methods described herein. A still further aspect of the invention relates to beef, with increased capability to retain liquid under cooking conditions as compared to beef without trehalose, prepared by various methods described herein.

In some embodiments, the present invention provides for methods of preparing beef, which include adding trehalose to beef in an amount sufficient to increase the cooked yield of the beef product relative to beef without trehalose. In some embodiments, whether the cooked yield is increased can be determined by comparing the normalized cooked weight of a first beef product comprising trehalose to the cooked weight of a second beef product that is substantially the same as the first beef product except that the second beef product includes dextrose in place of trehalose. (Or else, the cooked weight of the first beef product can be compared to the normalized cooked weight of the second beef product.)

The following definitions should be understood to apply from here on in. A “control” beef product is a beef product that does not contain trehalose and that is used as a comparison for a trehalose-containing beef product. For example, the second beef product described above is a control beef product. “Cooked weight” is understood to mean the weight of the beef product when the beef product reaches the desired internal temperature (or “cooked temperature”) safe for human consumption. “Substantially the same” should be understood to mean that the two beef products have the same composition, that is the two beef products include the same ingredients in the same relative ratios, except that the first beef product includes trehalose whereas the second beef product includes dextrose or additional beef in place of the trehalose. “Substantially the same” is also intended to take into account that some differences in the individual weight of components may occur between the trehalose-containing beef product and the dextrose-containing beef product, and consequently the normalized cooked yield of the trehalose-containing beef product is compared to the cooked yield of the dextrose-containing beef product. Example 9 in the Detailed Description section below illustrates the concepts of “substantially the same” and “normalized cooked yield.”

In some embodiments, the process comprises incorporating an amount of trehalose into beef to obtain a first beef product having a higher cooked yield relative to that of a second beef product, wherein the first beef product and the second beef product have a similar pre-cooked weight and each have a similar composition, except that the second beef product includes additional beef in lieu of trehalose. The phrase “similar pre-cooked weight” is intended to account for differences that may result due to limitations associated with the process of making the beef products. For example, the differences may be due to inherent inaccuracies in the measurement process, or human error that creates difficulties in making exact duplicates. “Similar composition” has the same meaning as “substantially the same” and indicates that the two products have the same ingredients in about the same ratios, except that the second beef product has dextrose or, as in the particular embodiment described, an additional amount of beef that is about the same as the amount of trehalose in the first beef product. The term “about” is intended to account for inherent inaccuracies in the measurement processes used, and should be understood to modify all measurements provided herein unless indicated otherwise. In some embodiments according to the invention, the trehalose is incorporated into the beef by adding a mixture of trehalose and water to the beef. In some embodiments according to the invention, the trehalose is incorporated into the beef by adding an aqueous solution of trehalose, salt, and sodium phosphate to said beef.

In some embodiments, a beef product is provided which includes beef and an amount of trehalose sufficient to increase the cooked yield of the beef product relative to a control beef product without trehalose. In some embodiments, whether the cooked yield is increased is determined by comparing the cooked weight of the trehalose-containing beef product to the cooked weight of a control beef product, which control beef product has a similar pre-cooked weight and similar composition as the trehalose-containing beef product except the control beef product includes dextrose or additional beef instead of trehalose.

In some embodiments, a method of increasing the normalized cooked yield of beef is provided. The method includes adding effective amounts of trehalose to beef, and optionally adding effective amounts of salt and/or sodium phosphate to obtain a normalized cooked yield, wherein when the beef is heated to a desired temperature safe for human consumption, the normalized cooked yield is higher than a cooked yield resulting from heating a substantially similar beef without trehalose to the same desired temperature. “Effective amounts of trehalose” should be understood from here on in to be an amount of trehalose sufficient to obtain a beef product having a normalized cooked yield, wherein when the beef is heated to a desired temperature safe for human consumption the normalized cooked yield is higher than a cooked yield resulting from heating a substantially similar beef without trehalose to the same desired temperature. “Effective amounts of salt and/or sodium phosphate” should be understood to mean from here on in an amount of salt and/or sodium phosphate added to a beef product containing trehalose sufficient to obtain the normalized cooked yield, wherein when the beef is heated to a desired temperature safe for human consumption, the normalized cooked yield is higher than a cooked yield resulting from heating a substantially similar beef without trehalose to the same desired temperature, when adding trehalose alone does not obtain such normalized cooked yield.

It will be apparent to one of ordinary skill in the art from the disclosure herein that specific embodiments of the present invention may be directed to one, some or all of the above-indicated aspects as well as other aspects. Further, while multiple embodiments are disclosed, still other embodiments of the present invention will become apparent to those skilled in the art from the following detailed description, which shows and describes illustrative embodiments of the invention. As will be realized from the description herein, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1. The influence of trehalose (2.0%) on the yield of frozen all-meat ground beef patties cooked to 160 deg F. and then held for 20 minutes at 175 deg F. Each value is the average of 5 individual patties. The standard error is shown by the error bars.

FIG. 2. The influence of trehalose (2.0%) on the yield of frozen all-meat ground beef patties and ground beef patties containing starch cooked to 160 deg F. and then held for 20 minutes at 175 deg F. Each value is the average of 5 patties. The standard error is shown by the error bars.

FIG. 3. Effect of trehalose on the yield of restructured roasts after cooking to 155 deg F. Values are averages of 3 roasts. Error bars show standard error. Trehalose (T)=2.0%, Sodium phosphate (STP)=0.48%, Salt=1.5%, ½ (STP+Salt)=0.24% STP+0.75% Salt.

FIG. 4. Effect of trehalose on the yield of injected whole muscle roasts after cooking to 145 deg F. Values are averages of 4 roasts. Error bars show the standard error. Trehalose (T)=1.1-1.6%, Sodium Phosphate (STP)=0.35%, Salt=0.7%.

FIG. 5. Changes in the mass composition of 4 cooked top rounds, each having an uncooked weight of 565 g but containing varying amounts of trehalose.

FIG. 6. Changes in the mass composition of 4 cooked top rounds, each having an uncooked weight of 589 g but containing varying amounts of trehalose.

FIG. 7. Changes in the mass composition of trehalose-containing cooked ground beef. 7 patties were analyzed, one each at 0, 5, 10, 15, 20, 25, and 30 minutes.

FIG. 8. A comparison of the commercial cooked yields of individual beef top rounds containing dextrose or trehalose.

### DETAILED DESCRIPTION OF THE INVENTION

The invention provides methods of using trehalose to increase the cooked yield of beef products compared to such products without trehalose. The present invention also provides beef products comprising trehalose, which beef products exhibit an increase in cooked yield relative to similar beef products without trehalose.

Trehalose (alpha-D-glucopyranosyl-alpha-D-glycopyranoside) is a disaccharide. It is a GRAS (Generally Regarded As Safe) food ingredient, typically found in mushrooms, honey, lobster, shrimp, and baker's yeast. The inventors have discovered that addition of trehalose to beef can increase the cooked yield of beef.

Without being bound by theory, the inventors believe that the increase in cooked yield corresponds in part to an increase in liquid retention. Trehalose was evaluated for its impact on cooked yield over a broad range of beef product categories, including ground beef patties, restructured beef roasts, and whole muscle beef roasts. In each category, loss of liquid during cooking and the associated shrinkage were evaluated. Loss of liquid reflects loss of water and liquid fat—collectively making up juice. The loss of juice during cooking is called juice cookout. Shrinkage during cooking reflects loss of liquid, and can be measured by weight loss of the meat. In each product category, trehalose reduced juice cookout and increased yields by about 1% to about 2%. Yield is understood to mean the ratio of the cooked weight to the pre-cooked weight. This was demonstrated using trehalose at low inclusion levels (from about 0.5% to about 2%). It should be understood that the percent of inclusion (for example of trehalose or other additives) is a weight percent based on the weight of the uncooked beef. In other words, a trehalose inclusion level of 0.5% means an amount of trehalose was added equal to 0.5% of the weight of the uncooked beef. It was also discovered that adding trehalose to beef can be done without having substantial alteration on the appearance, flavor, juiciness, or texture of the cooked product. Such trehalose functionality can have economic implications to meat processors such as: 1) reduced formulation costs due to substitution of beef with trehalose or water; and, 2) reduced raw material inputs to cooking processes due to higher yields.

Although trehalose was tested and found effective at inclusion levels from about 0.3% to about 2.0%, including levels of about 0.5%, 1.6% and 1.8%, the inventors believe that similar benefits can be obtained at lower levels. Similarly the inventors believe similar benefits can be obtained at higher levels, such as at 3%, 5%, and even higher levels.

The potential of trehalose to increase the yield of cooked meat was evaluated in ground beef patties, restructured beef roasts, and whole muscle beef roasts. All-meat patties containing trehalose (2.0%) were 1.8% heavier after frying than control patties. The increase occurred even though the patties contained 2.0% less meat to retain juice. A mass balance analysis of the juice expelled showed that the trehalose patties had a disproportionately lower juice loss (35.8 g/100 g potential juice) than the control patties (37.8 g/100 g potential juice). Cooked patties, held for 20 minutes at 175 deg F. to simulate food service preparation, retained the incremental weight gained until the patties were served. Although trehalose is a disaccharide, the cooked patties exhibited only a hint of sweetness, and the overall cooked flavor was desirable.

The juice retention with trehalose was compared to the juice retention with starch (breadcrumbs). The starch & meat patty displayed superior juice retention over the all-meat patty and the trehalose & meat patty as the patty yield increased by 6.4% and 4.6% respectively. However, combining starch with trehalose reduced the yield by 2.8% relative to starch alone. Further studies indicated that the order of addition of ingredients may impact the yield, and where the order was reversed the yield of patties having starch alone was the same as patties having starch and trehalose. Although the addition of trehalose did not increase the juice retention of the starch & meat patty, as described in the previous paragraph, adding trehalose alone increased the liquid retention of the all-meat patty.

The ability of trehalose to improve cooked yield was also evaluated in restructured beef roasts. When trehalose (2.0%) was added to a commercial formula containing salt and sodium phosphate, the weight of the cooked product increased by 0.9%. A sensory panel was unable to distinguish between the appearance, flavor, juiciness, and texture of a commercial roast containing trehalose. Therefore, trehalose has the potential to increase the yield of restructured roasts and maintain acceptable sensory characteristics.

Trehalose was also used in the solution injected into whole muscle beef roasts. Although when used alone, trehalose did not increase the weight of cooked roasts, when combined with salt and sodium phosphate in the commercial formula, trehalose (1.6%-1.8%) increased cook yield by up to 2.1% (P<0.05). Further dosage work suggested it may be possible to reduce trehalose levels to 1% or less and create comparable yield gains while maintaining acceptable sensory characteristics. Without being bound by theory, the inventor believes that salt and sodium phosphate enhance the roast's ability to retain trehalose. In other words, adding trehalose alone to the roast did not show an increase in cooked yield because the trehalose was not incorporated into the roast. However, addition of trehalose along with salt and sodium phosphate enabled incorporation of trehalose into the roast, and consequently an increase in cooked yield.

Salt is used in the examples contained herein at levels ranging from about 0.7% to about 1.5%. However the inventors believe that the specific amount of salt is not critical, and similar benefits can be obtained at lower levels and at higher levels of salt.

Similarly, sodium phosphate is used in the examples contained herein at levels ranging from about 0.24% to about 0.48%. However the inventors believe that the specific amount of sodium phosphate is not critical, and similar benefits can be obtained at lower levels and at higher levels of sodium phosphate.

A brief summary of improvements, which may offered by the inclusion of trehalose in meat, one or more of which may be present in various embodiments according to the invention, includes the following:

The shrinkage of meat during cooking is consistently reduced by the addition of trehalose.

The shrinkage of meat during cooking is consistently reduced by the addition of trehalose, salt, and sodium phosphate.

The shrinkage meat, with salt and sodium phosphate, during cooking is consistently reduced by the addition of trehalose.

The reduction of meat shrinkage which occurs in the presence of trehalose does not require the addition of starch.

The liquid retention of meat during cooking is consistently increased by the addition of trehalose.

The liquid retention of meat during cooking is consistently increased by the addition of trehalose, salt, and sodium phosphate.

The liquid retention of meat, with salt and sodium phosphate, during cooking is consistently increased by the addition of trehalose.

The increased liquid retention of meat which occurs in the presence of trehalose does not require the addition of starch.

As used herein, “consistently” means occurring sufficiently often under certain conditions to represent a meaningful conclusion under such conditions.

The above brief summary of improvements will become apparent to one of ordinary skill in the art from the following examples. The examples are intended to illustrate the spirit of the invention and certain embodiments of the invention, but not to restrict the invention. One of ordinary skill in the art, after reading the present disclosure of the invention, will be able to envision additional embodiments. It is the intent of the inventors that all such embodiments are included in the invention.

Example 1 provides a non-limiting example of trehalose-containing ground beef patties and the increased cooked yield exhibited by such patties. Example 2 provides a non-limiting example of the effect on the cooked yield on beef patties by a trehalose breadcrumb combination. Example 3 provides a non-limiting example of trehalose-containing restructured deli beef roasts and the increased cooked yield exhibited by such roasts. Example 4 illustrates the desirability of adding ingredients such as sodium phosphate and salt to aid in incorporation of trehalose into certain beef products such that the beef retains a sufficient amount of trehalose to obtain an increased cooked yield. Example 5 provides a non-limiting example of trehalose-containing beef top rounds and the increased cooked yield exhibited by such top rounds. Example 6 illustrates the cooked yield increase for varying inclusion levels of trehalose in beef whole muscle roasts. Example 7 provides a non-limiting example of the change in mass composition resulting from a variety of inclusion levels of trehalose in beef top rounds. Example 8 provides a non-limiting example of the changes in mass composition of trehalose-containing ground beef at different cooking times. Example 9 provides another non-limiting example of increased yield exhibited by beef top rounds containing trehalose.

### EXAMPLES

Ingredients for Examples

Sodium chloride, sodium phosphate, and dextrose were obtained from a Cargill, Inc. meat plant. Trehalose dehydrate was obtained from Hayashibara International (Japan). Trehalose dihydrate when placed in water forms a solution of free trehalose.

Statistical Analysis for Examples

Cook yield data analyses within the following examples were performed using standard statistical methodology, including standard statistical t tests, paired t tests, and analysis of variance (ANOVA).

### Example 1

### All Meat Ground Beef Patties

Ground beef patties were prepared at a Cargill, Inc. meat plant. Course ground beef (about ⅜″grind size) was formulated by grinding 90% lean beef with 50% lean beef to obtain a fat content of about 25%. Trehalose (2.0%) was mixed with water (2.75%) and then mixed with chilled (about 30 deg F.) ground beef for about 1 minute. The meat was then reground to about ⅛″ grind size before patty formation. As a control, water (2.75%) minus trehalose was mixed with ground beef prior to forming patties. Therefore, patties containing trehalose had 2.0% less meat than the control patties.

The present example illustrates comminuted meat, wherein comminuted meat is pre-rigor or post-rigor animal muscle tissue whose structure has been physically rearranged to fine pieces or particles.

Patty Formation

Patties were formed using a Formax 6 pilot-scale patty maker. A homestyle mold was used to form patties that were 0.5″ thick and weighed about 4.75 ounces. The mold was filled using the tenderform fill operating between 150 and 200 psi. Both sides of the patties were perforated using a knife or waffle perforation to speed the cooking process and reduce surface crusting. Patties were frozen immediately by conveying through an IQF (Individually Quick Frozen) freezer tunnel. Frozen patties were packaged in boxes and stored frozen until cooked. A total of 100 pounds of Example 1 patties and 100 pounds of Example 2 patties were produced. A portion of each set were control patties.

Cook Yield for the Patties

Frozen patties (at about 4 deg F.) were selected randomly from each batch for cooking. The patties were cooked on a commercial-style flat griddle (at about 350 deg F) to a final internal temperature of about 160 deg F. To achieve the desired temperature, patties were cooked for 6.5 minutes on one side, then flipped and cooked another 2.5 minutes on the other side. Patties were flipped again and cooked about 5 seconds to displace any surface juice. Starch patties of Example 2 were cooked similarly except that an additional 0.5 minutes per side was needed to reach 160 deg F. Cook yield was then determined based on the weight differences between the frozen and cooked patty. Thus, yield was calculated by dividing cooked weight by frozen weight and multiplying by 100.

To simulate conditions that exist inside a foodservice hot box, patties were placed in a small cake pan and covered with aluminum foil. The patty was then placed inside a convection oven (at 175 deg F.) for 20 minutes, removed, and reweighed. The holding yield was then calculated by dividing the holding weight by the frozen weight and multiplying by 100.

Results and Discussion

Trehalose was evaluated in all-meat beef patties to study its impact on cooking and holding yields (FIG. 1). Trehalose increased cook yield by an average of 1.8% (70.3% vs 68.5%). The increase in juice retention occurred even though the patties contained 2.0% less meat. Finally, the patties with trehalose exhibited only a hint of sweetness and the overall cooked flavor was desirable.

The trehalose patties contained less moisture and fat (potential juice) prior to cooking. However, the amount of expelled juice was disproportionately lower from the trehalose patty (35.8 g/100 g potential juice) than the control (37.3 g/100 g potential juice).

Holding the patties an additional 20 minutes at 175 deg F. to simulate a foodservice hot box reduced patty weight a similar amount (4.3%). Thus trehalose did not alter the relative juice retention during holding, and the incremental weight gained during cooking was maintained until the patty would be served.

### Example 2

### Beef Patties Containing Starch

Trehalose was added to ground beef patties that contained starch. Course ground beef was prepared as described above except for the following changes. Dry breadcrumbs (0.75%) were added to the meat first and mixed about 30 seconds. Trehalose (2.0%) was then mixed with water (2.75%) followed by the addition of seasoning (1.0%) and more breadcrumbs (0.75%). This mixture was added to the meat, mixed for 1 minute, and then reground to about 1/8” grind size before forming patties. To make the starch patty control, trehalose was omitted and the amount of ground beef was increased by 2.0%.

Patties were formed and cook yield was determined using the procedures described for example 1. Similarly to example 1, the present example also illustrates comminuted meat.

Results and Discussion

As mentioned earlier, it is generally believed that the starch from breadcrumbs improves juiciness by improving water and fat retention. Hence, ground beef patties containing starch were chosen as an example to compare the functionality of trehalose with that of starch.

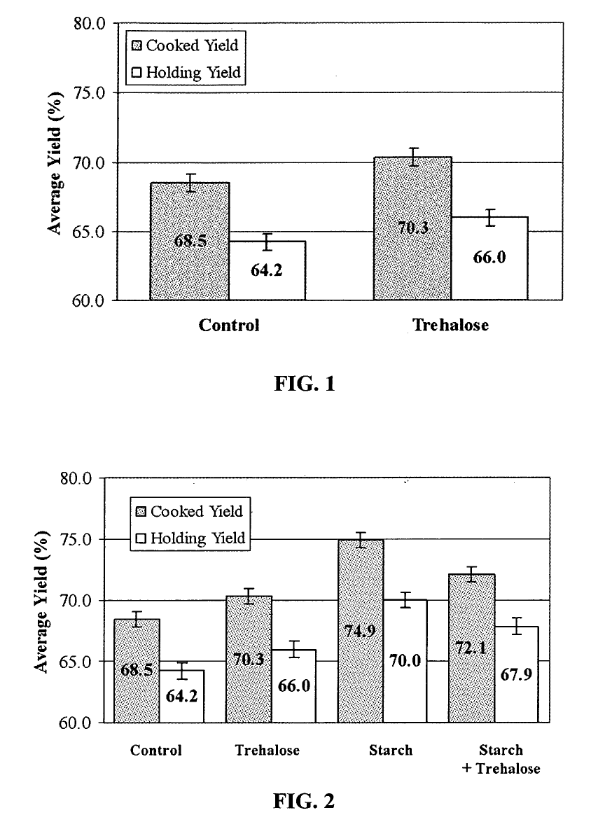

FIG. 2 plots the cook yield of the starch patty and compares it to the cook yield of the all-meat patty of Example 1. The figure shows that starch increased the yield (from 68.5% to 74.9%), and that starch also provided better juice retention than trehalose (74.9% to 70.3). In addition, the figure shows that starch alone provided better juice retention than trehalose and starch together (74.9% to 72.1%).

Although combining breadcrumbs with trehalose had a negative effect on patty yield, as compared to patties with breadcrumbs done, as shown in FIG. 1, trehalose enhances patty yield without using starch.

### Example 3

### Restructured Beef Roasts

Restructured deli beef roasts were manufactured at a Cargill, Inc. meat plant. The roasts were prepared by grinding chilled (40-45 deg F.) XXX grade fresh beef into chunks using a 1 ¼″ plate. An aqueous brine solution was prepared by dissolving sodium phosphate in water followed by sodium chloride (salt). Trehalose was added after the salt and then the brine was kept cold (40-45 deg F.) prior to use. In addition, an aqueous solution was similarly prepared of trehalose alone. Further, a control aqueous bath having substantially only water was similarly prepared. As used herein, the term “brine” collectively describes the aqueous bath and the various aqueous solutions described in this paragraph.

Beef chunks and the various brine solutions were mixed for about 20 minutes to impregnate the meat with the various solutions and to extract surface proteins which promotes binding of the restructured roast. The meat and brine mixture was then transferred to clear plastic bags (to weights of 10.0 pounds), purged of excess air, and then heat sealed. The roasts were then kept cold overnight to promote additional protein extraction before cooking. A total of three replicates of each roast formula were prepared.

Using this procedure, roasts were prepared in the following categories:

Control roasts mixed with the water bath.

Roasts mixed with the solution of trehalose alone such that the resultant roasts contained 2.0% Trehalose.

Roasts mixed with the solution of salt and sodium phosphate such that the resultant roasts contained 1.5% salt and 0.48% sodium phosphate.

Roasts mixed with the solution of trehalose, salt and sodium phosphate such that the resultant roasts contained 2.0% trehalose, 0.75% salt and 0.24% sodium phosphate.

Roasts mixed with the solution of trehalose, salt, and sodium phosphate such that the resultant roasts contained 2.0% Trehalose, 1.5% salt, and 0.48% sodium phosphate.

The roasts were cooked in a smokehouse set at 175 deg F. and 90% relative humidity to core temperatures of 155 deg F. Cooked roasts were then chilled to about 40 deg F., stored for four days, and then the bags and exudate were discarded. The roasts were then weighed to determine the cook yield by dividing cooked weight by uncooked weight and multiplying by 100.

Following the yield measurements, one roast from each treatment was sliced in half and evaluated by an 8-member sensory panel. The panel consisted of meat scientists who have extensive experience evaluating the quality of meat products. The roasts were scored based on appearance, flavor, juiciness, texture, and overall acceptability using an 8-point hedonic scale ranging from 1 (extremely undesirable) to 8 (extremely desirable). The identity of each roast was unknown to the panelists until the evaluation concluded.

The present example illustrates restructured meat, wherein restructured meat includes muscle pieces, muscle trimmings, or comminuted muscle particles that are combined to resemble whole muscle products. Restructured meat includes parts of muscle, fat, and other materials normally associated with muscle.

Results and Discussion

Restructured roasts contain lower value beef trimmings that are reformed to resemble intact, whole muscle. They have firm textures that permit thin slicing for sandwiches, entree ingredients, and deli trays. Their assembly relies heavily on salt and sodium phosphate to extract the proteins for binding the pieces together when cooked. The present interest in restructured roasts centered on the potential liquid retention functionality of trehalose and whether trehalose could be used with salt and sodium phosphate to increase cook yields.

During the mixing and bagging of raw ingredients, it was learned that salt and sodium phosphate appear to aid the absorption of water and trehalose. This was most apparent in the absence of salt and sodium phosphate, or when their levels were halved, as the meat had a watery exudate. In contrast, meat mixed with the full levels of salt and sodium phosphate had no watery exudate and exhibited a creamy texture.

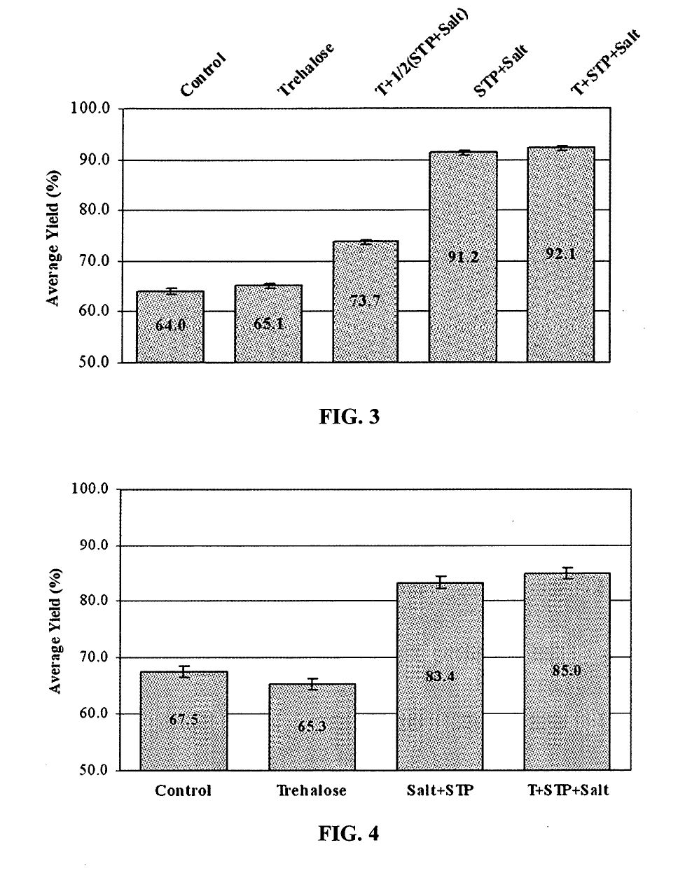

The yield results for restructured roasts are plotted in FIG. 3. Eliminating or halving the levels of salt and sodium phosphate lowered the yields substantially. Roasts with no salt or sodium phosphate gave the lowest yields (control 64.0% and trehalose 65.1%). Adding salt and sodium phosphate increased yields to 73.7% and 92.1% for half and full salt and sodium phosphate levels, respectively. When trehalose was combined with salt and sodium phosphate, it raised the yield about 1% (from 91.2% to 92.1%).

A sensory panel evaluated the quality of each roast after chilling for four days (Table 1). Quality was scored using an 8-point hedonic scale ranging from 1, for an extremely undesirable response, to 8 for an extremely desirable response. Thus, higher scores were indicative of higher quality. Overall, roasts containing salt and sodium phosphate were preferred over roasts with water or trehalose alone. However, when trehalose was combined with salt and sodium phosphate, the roast appearance, flavor, juiciness, and texture were virtually indistinguishable. Therefore, trehalose has the potential to increase the cook yield or restructured roasts about 1% without altering the sensory quality.

TABLE 1
The Sensory Quality of Restructured Beef Roasts Following Cooking

| | Average Sensory Score | | | | |
|---|---|---|---|---|---|
| Treatments | Appearance | Flavor | Juiciness | Texture | Overall |
| Control | 2.0^{a} | 2.1^{a} | 3.3^{a} | 2.3^{a} | 2.3^{a} |
| Trehalose | 2.3^{a,b} | 2.6^{a,b} | 3.5^{a,b} | 2.3^{a} | 2.3^{a} |
| T + ½(STP + | 4.0^{b,c} | 4.3^{b,c} | 4.4^{a,b,c} | 4.0^{a,b} | 4.0^{b} |
| Salt) | | | | | |
| STP + Salt | 3.8^{a,b,c} | 4.6^{c} | 5.5^{c} | 4.3^{b} | 4.0^{b} |
| T + STP + Salt | 4.6^{c} | 4.4^{c} | 5.3^{b,c} | 4.1^{b} | 4.1^{b} |

Please refer to FIG. 3 for the concentrations of each treatment.
T = Trehalose,
STP = Sodium Phosphate.
Sensory scores with different superscripts are significantly different (P < 0.05) within the column.

### Example 4

### Whole Muscle Beef Roasts

Injected whole muscle beef roasts were manufactured at a Cargill, Inc. meat plant. The roasts were prepared using fresh UTE cap-off top rounds. A brine solution was prepared by mixing sodium phosphate with water followed by dextrose, salt, seasoning, and trehalose. In addition, an aqueous solution was prepared of trehalose alone. Further, a control aqueous bath having substantially only water was prepared. Again, as used herein, the term “brine” collectively describes the aqueous bath or the various aqueous solutions described in this paragraph.

The roasts were injected with the various brine solutions to increase their weight by 30% (30% over green weight). After each injection the solution was substantially distributed throughout the injected roast. The injected roasts were then tumbled at 5 rpm for 60 minutes at 40 deg F. under vacuum (about minus 0.9 bar) to distribute brine evenly throughout the muscle. Tumbled roasts were then weighed into clear plastic bags, vacuum sealed, and chilled overnight prior to cooking. A total of four replicates of each roast were prepared.

Using this procedure, roasts were prepared in the following categories:

Control roasts injected with the water bath.

Roasts injected with the solution of trehalose alone such that the resultant roasts contained 1.1% to 1.6% trehalose.

Roasts injected with the solution of salt and sodium phosphate such that the resultant roasts contained 0.7% salt and 0.35% sodium phosphate.

Roasts injected with the solution of trehalose, salt, and sodium phosphate such that the resultant roasts contained 1.1% to 1.6% trehalose, 0.7% salt, and 0.35% sodium phosphate.

The roasts were submerged in hot water (160 deg F.) and cooked to an internal temperature of 145 deg F. Cooked roasts were chilled to about 40 deg F. for four days and then the bags and exudate were discarded. The roasts were weighed to determine the cook yield by dividing cooked weight by uncooked weight and multiplying by 100.

After weighing, one roast from each group was sliced in half and evaluated by an 8-member panel of meat scientists. The panelists judged the appearance, flavor, juiciness, texture, and overall acceptability using an 8 point hedonic scale ranging from 1 (extremely undesirable) to 8 (extremely desirable). The identity of each roast was unknown to the panelists until the evaluation concluded.

Results and Discussion

Injected whole muscle beef roasts are another type of delicatessen meat. They are typically injected with water, salt, and sodium phosphate to increase juiciness and yield. The present interest in this product was to compare the yield produced by injection with trehalose to that produced by injection with water alone and to that produced by injection with salt and sodium phosphate.

Once the roasts were injected and bagged they were weighed to determine the actual brine retention. Roasts injected with water (control), or with trehalose, retained less brine (about 15%) than roasts injected with salt and sodium phosphate, or with trehalose, salt, and sodium phosphate (about 22%). Therefore, salt and sodium phosphate improved trehalose uptake by the meat tissue during the injection phase.

The cook yields for each roast are plotted in FIG. 4. As expected, addition of water produced a significantly lower yield (67.5%) than roasts containing salt and sodium phosphate (83.4%). Trehalose alone did not increase the yield (65.3%), but when combined with salt and sodium phosphate, it raised the yield by 1.6% (from 83.4% to 85.0%). Although trehalose alone did not increase the yield, it is believed that with further study methods might be found for trehalose alone to enhance the yield of whole muscle beef roasts.

A sensory panel again evaluated the quality of each roast for appearance, flavor, juiciness, and texture. The results of the evaluation are shown in Table 2. As can be seen, the sensory panel preferred the appearance, flavor, and juiciness of roasts containing salt and sodium phosphate. However, when trehalose and salt and sodium phosphate were used together, the roast appearance, flavor, and juiciness were virtually indistinguishable from the results for salt and sodium phosphate without trehalose. However with the trehalose, the meat texture was tighter, providing visual evidence that trehalose was affecting the meat structure.

TABLE 2
The Sensory Quality of Injected Whole Muscle Roasts Following
Cooking

| | Average Sensory Score | | | | |
|---|---|---|---|---|---|
| Treatments | Appearance | Flavor | Juiciness | Texture | Overall |
| Control | 5.3^{a} | 3.7^{a} | 4.2^{a} | 3.3^{a} | 3.8^{a} |
| Trehalose | 5.1^{a} | 4.7^{a,b} | 3.7^{a} | 4.6^{a,b} | 4.4^{a} |
| STP + Salt | 5.5^{a} | 5.7^{b} | 6.1^{b} | 5.6⁶ | 5.4^{a} |
| T + STP + Salt | 5.5^{a} | 5.2^{b} | 5.8^{b} | 4.3^{a,b} | 4.8^{a} |

Refer to FIG. 4 for the concentration of each treatment.
T = Trehalose,
STP = Sodium Phosphate.
Sensory scores with different superscripts are significantly different (P < 0.05) within the column.

An analysis of the cooking data revealed that the size of the roasts could have influenced the yields since larger roasts tended to have higher yields than smaller roasts. This seemed logical as the cook times were the same for every roast. Cooking was stopped once the temperature of a single, intermediate-sized roast reached 145 deg F. so the temperature at the center of larger roasts would be lower than the temperature of smaller roasts. The higher temperatures would cause smaller roasts to experience more protein denaturation, loss of protein solubility, and less liquid retention than larger roasts.

The roasts were sourced from multiple beef cows so genetic differences were another variable. It is well recognized that protein solubility and liquid retention can vary widely between cows. In our study, a single cow provided two roasts so a minimum of eight cows were needed to provide sixteen roasts for the control, the trehalose alone, the salt+sodium phosphate, and the trehalose+salt+sodium phosphate treatments. Because an attempt was not made to segregate the roasts from the same group of eight cows, it is possible the genetic variations spanned up to eight cows.

### Example 5

### Whole Muscle Beef Roasts

To control for the variation in animal genetics and roast size, another study was designed. Pairs of top rounds from single cows were segregated such that one roast from each pair served as a control (containing salt+sodium phosphate), and the second roast of each pair served as a treated roast (salt+sodium phosphate+trehalose). A total of six roast pairs were obtained to strengthen the statistical validity of the results. The pairs of roasts were then trimmed such that each roast was within 0.1 pounds of its mate before injection. This equalized the weights to improve heat transfer and develop more uniform cooking temperatures.

The roasts were injected in a manner similar to that described in example 4. Using this procedure, roasts were prepared in the following categories:

Control roasts injected with the solution of salt and sodium phosphate such that the resultant roasts contained 0.7% salt and 0.35% sodium phosphate.

Roasts injected with the solution of trehalose, salt, and sodium phosphate such that the resultant roasts contained 1.6% to 1.8% trehalose, 0.7% salt, and 0.35% sodium phosphate.

Roasts injected with the solution of trehalose, salt, and sodium phosphate such that the resultant roasts contained 0.9% trehalose, 0.7% salt, and 0.35% sodium phosphate.

Roasts injected with the solution of trehalose, salt, and sodium phosphate such that the resultant roasts contained 0.5% trehalose, 0.7% salt, and 0.35% sodium phosphate.

Results and Discussion

The yield results for each roast pair are tabulated in Table 3. Trehalose increased the yield in 5 of the 6 pairs by an average of 2.1% (90.1% vs 88.0%).

TABLE 3
Effect of Trehalose on the Cook Yield of Whole Muscle Roasts
Using a Paired Experimental Design to Control for Genetic
Variability

| | Cook Yield (%) | | | | | | |
|---|---|---|---|---|---|---|---|
| | | STP + | | STP + | | STP + | |
| | | Salt + | | Salt + | | Salt + | |
| | STP + | Trehalose | | Trehalose | | Trehalose | |
| Roast | Salt | (1.6%-1.8%) | | (0.9%) | | (0.5%) | |
| Pair | [Control] | | Yield | | Yield | | Yield |
| # | Yield | Yield | Increase | Yield | Increase | Yield | Increase |
| 1 | 86.3 | 89.8 | 3.5 | | | | |
| 2 | 88.5 | 90.1 | 1.6 | | | | |
| 2 | 89.5 | 91.2 | 1.7 | | | | |
| 4 | 89.7 | 88.9 | −0.8 | | | | |
| 5 | 87.2 | 88.5 | 1.3 | | | | |
| 6 | 88.6 | 90.7 | 2.1 | | | | |
| Average | 88.3 | 89.9 | 1.6 | 89.7 | 1.4 | 89.8 | 1.5 |

Initially, the work focused on studying trehalose at a single dosage (1.6-1.8%). The study was then continued at lower concentrations to evaluate the response at lower concentrations. Also, there was an incentive to see if lower levels might alleviate the tight texture. The strategy was to inject two roasts from a single cow with 0.5% trehalose and two more roasts from a second cow with 0.9% trehalose. We cooked the roasts together with the roasts from Table 3 and compared their yields.

Roasts containing 0.5% and 0.9% trehalose had similar yields as roasts containing 1.6%-1.8% trehalose (89.8%, 89.7%, and 89.9%, respectively). This translated to an average yield increase of 1.5% over the controls. Lowering the trehalose levels also tended to reduce the tight texture and improve the overall sensory quality (Table 4). The sensory panel was unable to distinguish between the roasts when the trehalose levels were reduced to less than 1%.

TABLE 4
The Effect of Trehalose Concentration of the Sensory Quality
of Whole Muscle Roasts Injected with Salt (0.8%) and
Sodium Phosphate (0.4%).

| Trehalose | | | | | |
|---|---|---|---|---|---|
| Concentration | Average Sensory Score | | | | |
| (%) | Appearance | Flavor | Juiciness | Texture | Overall |
| 0 | 4.8^{a} | 4.8^{a} | 5.6^{a} | 4.6^{a} | 5.1^{a} |
| 0.5 | 4.6^{a} | 4.3^{a} | 5.4^{a} | 4.8^{a} | 4.7^{a} |
| 0.9 | 4.4^{a} | 4.8^{a} | 5.4^{a} | 4.8^{a} | 5.0^{a} |
| 1.8 | 4.4^{a} | 4.1^{a} | 5.3^{a} | 4.4^{a} | 4.2^{a} |

Sensory scores with different superscripts are significantly different (P < 0.05) within the column.

### Example 6

The cooked yield experiment detailed in Example 5 was repeated for varying inclusion levels of trehalose in beef whole muscle roasts. The yield increase was plotted against trehalose inclusion levels and the results are provided in table 5 below.

[image]

### Example 7

Cooked top rounds were prepared according to the procedure having 1%, 2% and 3% trehalose inclusion levels, and the mass composition of each of those cooked top rounds was compared to a control (cooked top round with no trehalose).

Ingredients. Most of the ingredients were obtained from Emmpak Food's Milwaukee, Wis. ingredient inventory. They comprised utility grade beef inside top rounds, sodium chloride (salt), and sodium phosphate (STP). Trehalose was purchased from Hayashibara (Japan). All meat samples were sourced from the same animal to equalize genetics and post-mortem aging conditions across all treatments.

Meat Preparation. A brine solution was prepared first by dissolving STP, salt, and trehalose in water. The top rounds were sectioned into about 1 pound samples and then mechanically tenderized using a needle-style tenderizer. The samples were injected with brine using a syringe-type meat injector to increase the weight by 30% (30% over green weight). This added about 0.8% salt, 0.35% STP, and up to 3.0% trehalose, by weight, to the raw meat. The samples were then tumbled at 5 rpm for 30 minutes at 40° F. under vacuum (25 inHg) to help distribute the brine. Tumbled samples were then weighed into polyethylene bags, vacuum-sealed, and chilled overnight prior to cooking. Duplicate samples were prepared at each trehalose treatment level.

Cooking Procedure and Yield Determination. The samples were submerged in hot water (145° F.) for 100 minutes until the internal center temperature reached about 145° F. Cooked samples were chilled to about 40° F. for 1 day and then removed from the bags to determine the cook yield. Cook yield was calculated by dividing cooked weight by uncooked weight and multiplying by 100. The juice was then analyzed for moisture, fat, protein, and trehalose to facilitate the mass balance analysis.

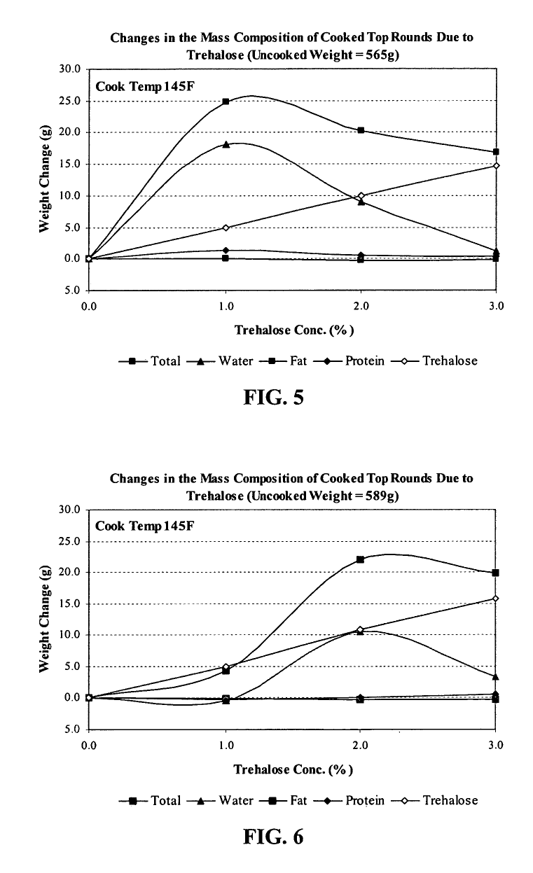

Changes in the Mass Composition of Cooked Meat. Changes in the mass of water, fat, protein, and trehalose were determined by mass balance analysis. The mass composition of cooked meat was determined by subtracting the mass composition of the juice from the mass composition of the uncooked meat. The mass composition of the uncooked meat was calculated from the amount of ingredients used to prepare the samples. The mass composition of the juice was determined from the amount of juice and its analysis. Results of the study are provided in FIGS. 5 and 6.

### Example 8

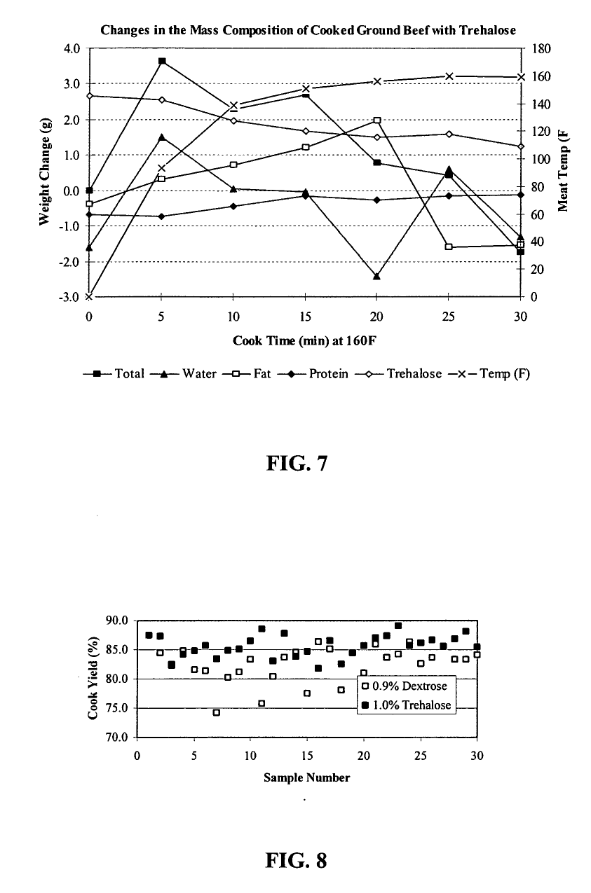

Ground beef patties were prepared with about 1.8% trehalose and without trehalose according to the procedure outlined in Example 1. The patties were cooked at 160 degrees F., and the difference in the mass composition between the 1.8% trehalose-containing patty and control patty was determined at five minute intervals ranging from 0 minutes to 30 minutes. The result of the study is provided in FIG. 7.

### Example 9

### Technical Abstract

The ability of trehalose to increase the yield of roast beef top rounds was evaluated during commercial processing. Two consecutive product runs of about 1800 pounds each were completed over a 4-day period. The products were injected, tumbled, bagged, cooked, cooled, and eventually packaged using equipment and conditions that were held as constant as commercial circumstances would permit. The first run produced the current commercial product with dextrose (0.9% by weight) and served as the control. The second run substituted trehalose (1.0% by weight) for dextrose and served as the test. The cook yield was quantified by sacrificing 30 roasts per run and measuring their individual yields after cooking and cooling. This allowed the roast-to-roast variability to be determined and strengthened the statistical validity of the results. Substituting trehalose for dextrose increased cook yield by 3.3% and the difference was highly significant (P=0.01). The increase was confirmed by the packaged product data (3.6% yield gain) and meant that the products remained heavier through packaging. A mass balance analysis of the cooking process was completed and it showed that water retention accounted for ˜76% of the weight gain. Continued monitoring of the cooked product purge (juice release) for an additional 2 months confirmed that the extra juice was mostly retained throughout the product shelf-life. Lastly, the yield benefits from trehalose were realized without adversely impacting the sensory acceptability of the products.

Materials and Methods:

Ingredients. Most ingredients were obtained from Emmpak's Milwaukee, Wis. ingredient inventory. They comprised utility grade cap-off inside top rounds, sodium chloride (salt), sodium phosphate (STP), dextrose, trehalose, hydrolyzed vegetable protein (HVF-53), beef flavoring, seasoning rub, and sodium lactate. Trehalose was purchased from Hayashibara (Japan).

Composition of beef Top Rounds Prior to Cooking. The composition of top rounds from both runs following injection and tumbling are compared in Table 6. The ingredient levels are average values and were obtained from the plant records. Both runs were injected similarly (dextrose: 132% of green weight, i.e. 100 lbs meat, 32 lbs brine; trehalose: 131% of green weight, i.e. 100 lbs meat, 31 lbs brine;) so they received comparable salt, STP, flavoring, and preservative dosages. Since the trehalose level was slightly higher than the dextrose level (0.99% vs. 0.86%), the trehalose brine contained less water to accommodate the extra carbohydrate. However, this did not significantly alter the moisture, fat, or protein content as shown in Table 7.

TABLE 6
Average Ingredient Levels for Beef Top
Rounds Following Injection and Tumbling.

Percent by Weight

| Ingredient | Dextrose Roasts | Trehalose Roasts |
|---|---|---|
| Beef Top Rounds | 75.68 | 76.44 |
| Water | 15.59 | 14.83 |
| Dextrose | 0.86 | 0 |
| Trehalose | 0 | 0.99 |
| Salt | 0.86 | 0.82 |
| STP | 0.38 | 0.36 |
| HVF-55 | 0.53 | 0.52 |
| Beef Flavoring | 1.07 | 1.03 |
| Rub | 2.89 | 2.91 |
| Sodium Lactate (60%) | 2.14 | 2.06 |
| Total | 100.00 | 99.96 |

TABLE 7
Average Moisture, Fat, and Protein Content of
Beef Top Rounds Following Injection and Tumbling.

^{a}Percent by Weight

| Composition | Dextrose Roasts | Trehalose Roasts |
|---|---|---|
| Moisture | 74.7 | 74.6 |
| Fat | 2.0 | 2.0 |
| Protein | 16.6 | 16.7 |

^{a}Calculated assuming the top rounds contained an average of 75.6% moisture, 2.6% fat, and 21.1% protein.

Plant Manufacturing Steps. Top rounds were injected, tumbled, bagged, cooked, stripped, rebagged, post-pasteurized, chilled, and packaged using commercial equipment and procedures. A total of two production runs were completed; the 1^{st} run comprised the current commercial formula (0.9% dextrose) and the 2^{nd} run replaced dextrose with trehalose (1.0%). Approximately 1800 pounds of cooked product (about 145 pieces) was produced. An outline of the manufacturing steps and their corresponding conditions are shown in Table 8.

TABLE 8
Manufacturing Steps Used to Produce
Emmber Classic Beef Top Rounds.

| Manufacturing | Conditions | |
|---|---|---|
| Steps | Dextrose Roasts | Trehalose Roasts |
| Injection | 132% of green weight | 131% of green weight |
| Tumbling | Time: 2.0 hrs | Time: 2.0 hrs |
| | Vacuum: 23 inHg | Vacuum: 20 inHg |
| | Temp: 44° F. | Temp: 43° F. |
| | Speed: 5 rpm | Speed: 5 rpm |
| Bagging & | Time: 4.7 hrs | Time: 4.1-9.2 hrs |
| Holding | Temp: 35-40° F. | Temp: 35-40° F. |
| Cooking | Time: 5.2-5.4 hrs | Time: 5.0-5.5 hrs |
| | Internal Temp: 151-154° F. | Internal Temp: 151-154° F. |
| | Water Temp: 167-170° F. | Water Temp: 167° F. |
| Cooling | Time: 4.5-6.5 hrs | Time: 5.0-5.9 hrs |
| | Internal Temp: 38° F. | Internal Temp: 38° F. |
| Stripping | Temp: 35-40° F. | Temp: 35-40° F. |
| Rebagging | Temp: 35-40° F. | Temp: 35-40° F. |
| Post- | Time: 2 min | Time: 2 min |
| Pasteurization | Surface Temp: 190-212° F. | Surface Temp: 190-212° F. |
| Chilling | Temp: 35-40° F. | Temp: 35-40° F. |
| Packaging | Temp: 35-40° F. | Temp: 35-40° F. |

Cook Yield Determination. To determine the cook yield, 30 roasts from each run were randomly chosen, individually weighed, and labeled prior to cooking. Then the labeled roasts were cooked and cooled along with the unlabeled roasts. Thus, the labeled and unlabeled groups received the same cooking and cooling treatments. After cooling, the 30 labeled roasts were located, stripped of their cook bags, and individually reweighed. The yield of each roast was then calculated by dividing its cooked weight by its uncooked weight and multiplying by 100.

Changes in the Mass Composition of Beef Top Rounds During Cooking. Changes in the mass of water, fat, protein, dextrose, and trehalose due to cooking were determined by mass balance analysis. The mass composition of cooked meat was determined by subtracting the mass composition of the juice from the mass composition of the uncooked meat. The uncooked meat composition was calculated using Tables 1 and 2 and its weight prior to cooking. The juice composition was determined by weighing the juice that accumulated in the cook bags and analyzing its composition.

Cooked Product Purge During Storage. Purge was measured as the juice that accumulated during storage at about 35° F. in evacuated polyethylene bags. The products were removed after one month and reweighed to measure the weight loss. Then they were repackaged and weighed again after two months.

Sensory Analysis of Cooked Products. A triangle difference test was conducted using a 30-member panel composed of Emmpak employees. A single roast from the dextrose run and one from the trehalose run were sliced into 2-3 mm thick slices and served chilled. The panelists were given 3 samples (2 were identical and 1 was different) and asked to identify which sample was different. Then if a difference was detected, they were asked to identify which sample they preferred and why.

Results and Discussion:

Cook Yield. To design the trial, we needed to know the roast-to-roast yield variability that exists during commercial production. However, this number is not generally known because plants don't monitor yield on an individual roast basis. Therefore, we applied the data from our pilot plant studies and estimated that 30 roasts per run would be sufficient to detect a statistically significant yield gain of 1.1% or more (P<0.05). Thus, this approach allowed us to distinguish between significant yield gains and process-related noise.

The cook yields for the 30 roasts from each run are plotted in FIG. 8. Each symbol represents a single roast so these were averaged to compare the runs. Trehalose increased the average yield by 3.3% (85.6% vs. 82.3%) and the gain was highly significant (P=0.01). The plant reported a similar yield gain of 3.6% (trehalose 82.3%, dextrose 78.7%) when they weighed the unlabeled roasts (˜115 from each run). The plant values may be lower because they weighed the roasts when they were packaged. However, the plant data confirmed that the yield gains observed following cooking were maintained through packaging.

A mass balance analysis of each run was conducted using the data in Table 9. The mass of moisture, fat, protein, dextrose, and trehalose in the cooked meat was determined by subtracting the mass composition of the meat juice from the mass composition of the uncooked meat. Since the roasts with dextrose were heavier prior to cooking (15.3 lbs vs. 14.0 lbs), the data from the trehalose roasts were normalized (adjusted on an equivalent uncooked weight basis) to allow direct comparison.

Using this method, we accounted for about 95% of the change in mass during cooking and essentially closed the mass balance around each commercial run. On average, the roasts with trehalose were about 0.5 pounds heavier than roasts with dextrose (13.1 lbs vs. 12.6 lbs). Most of the weight gain (76%) was due to moisture retention as the roasts averaged 0.38 lbs more water. The balance of the weight gain (24%) was due to trehalose and protein retention (0.12 lbs). Thus, trehalose promoted water retention in cooked top rounds which resulted in heavier products.

TABLE 9
The Mass Composition of Commercially
Cooked Beef Top Rounds Containing
Dextrose (0.9%) or Trehalose (1.0%).

| | Average Mass (lbs) in Cooked Roasts (N = 30) | | | |
|---|---|---|---|---|
| | Dextrose | Trehalose | Trehalose | *Difference |
| Component | Roasts | Roasts | (Normalized) | w/Trehalose |
| Cook Yield (%) | 82.4 | 85.7 | 85.6 | +3.2 |
| Uncooked Weight | 15.3 | 14.0 | 15.3 | 0 |
| Cooked Weight | 12.6 | 12.0 | 13.1 | +0.5 |
| Moisture Wt. | 9.17 | 8.75 | 9.55 | +0.38 |
| Fat Wt. | 0.31 | 0.28 | 0.31 | 0 |
| Protein Wt. | 2.45 | 2.28 | 2.49 | +0.04 |
| Dex or Tre Wt. | 0.04 | 0.11 | 0.12 | +0.08 |
| Total Wt. | 11.97 | 11.42 | 12.47 | +0.50 |

*Calculated as the difference between trehalose (normalized) and dextrose.

Cooked Product Purge During Storage. The loss of juice during product storage was evaluated by reweighing the roasts periodically (Table 10). This study was carried out for two months because it reflected the shelf-life of the product. The roasts containing trehalose tended to have slightly more purge (about 0.4% more) than dextrose roasts but the differences were borderline significant (one month) or not significant (two months). Therefore, roasts containing trehalose are expected to exhibit similar purge during storage and distribution as roasts containing dextrose.

TABLE 10
Purge Formation During Storage for
Up to Two Months at 35° F.

| Storage | Average Cumulative Purge (%) | | |
|---|---|---|---|
| Time | from Cooked Roasts (N = 27) | | |
| (Days) | Dextrose Roasts | Trehalose Roasts | P-Value |
| 0 | 0 | 0 | N/A |
| 33 | 6.3 | 6.7 | 0.08 |
| 63 | 7.9 | 8.3 | 0.56 |

Sensory Analysis Study. A triangle difference test was conducted using 30 Emmpak employees to determine if sliced beef with trehalose was distinguishable from sliced beef containing dextrose. The panelists were served 3 samples (2 were the same and 1 was different) and asked to identify which sample was different. Over one-half of the panelists (16 of 30) correctly identified the odd sample, which means they could distinguish between the two roasts (P<0.05). The panelists also were asked to choose which sample they preferred and the majority (57%) preferred the roast with trehalose. The remaining panelists either preferred the dextrose roast (10%) or had no preference (33%).

Having illustrated and described the principles of the invention in multiple embodiments and examples, it should be apparent to those skilled in the art that the invention can be modified in arrangement and detail without departing from such principles. We claim all modifications coming within the spirit and scope of the following claims.

We claim:

1. A method for preparing meat, comprising: adding trehalose to beef in an amount sufficient to obtain a first beef product having a normalized cooked yield higher than a second beef product, wherein the second beef product is substantially the same as the first beef product except that the second beef product includes dextrose in place of the trehalose.

2. A method according to claim 1, wherein the first beef product further comprises dextrose.

3. A method according to claim 1, further comprising adding at least one food ingredient to the beef, wherein the at least one food ingredient is added prior to, simultaneously with, or after adding the trehalose.

4. A method according to claim 1, wherein the first beef product is chosen from ground beef patties, restructured beef roasts, and injected whole muscle beef roasts.

5. A method according to claim 1, further comprising cooking the first beef product.

6. A method according to claim 1, wherein the trehalose is distributed throughout the beef.

7. A method according to claim 1, wherein the first beef product further comprises salt and sodium phosphate.

8. A method according to claim 3, wherein the at least one food ingredient is at least sodium phosphate.

9. A method according to claim 1, wherein the first beef product contains substantially no starch.

10. A method according to claim 1, wherein the beef is chosen from muscle, comminuted meat, and restructured meat.

11. A method according to claim 1, wherein the beef has a green weight, and the amount of trehalose is less than or equal to about 3% of the green weight of the beef.

12. A method according to claim 11, wherein the amount of trehalose is less than or equal to about 2% of the green weight of the beef.

13. A method according to claim 12, wherein the amount of trehalose ranges from about 0.3% to about 3% of the green weight of the beef.

14. A method according to claim 13, wherein the amount of trehalose ranges from about 0.5% to about 2% of the green weight of the beef.

15. A method for using trehalose, comprising: incorporating an amount of trehalose into beef to obtain a first beef product having an improved cooked yield relative to that of a second beef product, wherein the first beef product and the second beef product each have a similar pre-cooked weight and each have a similar composition, except that the second beef product includes additional beef in lieu of trehalose.

16. A method according to claim 15, wherein the trehalose is incorporated into said beef by adding a mixture of trehalose and water to said beef.

17. A method according to claim 15, wherein the trehalose is incorporated into said beef by adding an aqueous solution of trehalose, salt, and sodium phosphate to said beef.

18. A method according to claim 15, wherein the first beef product contains starch.

19. A beef product, comprising: beef and trehalose, wherein the beef product has a pre-cooked weight, and includes trehalose in an amount sufficient to increase the cooked yield of the beef product relative to a control beef product, wherein the control beef product has substantially the same pre-cooked weight as the beef product and has a composition similar to the beef product except that the control beef product includes dextrose or additional beef instead of trehalose.

20. A beef product according to claim 19, wherein the beef has a green weight, and the amount of trehalose ranges from about 0.3% to about 3.0% of the green weight of the beef.

21. A beef product according to claim 19, wherein the amount of trehalose ranges from about 0.5% to about 2.0% of the green weight of the beef.

22. A beef product according to claim 21, wherein the beef product is chosen from ground patties, restructured roasts, and whole muscle top rounds.

23. A beef product according to claim 22, wherein the beef product is chosen from restructured roasts and whole muscle top rounds and the beef product further comprises salt and sodium phosphate.

24. A method of increasing the normalized cooked yield of beef, comprising: adding effective amounts of trehalose to beef and optionally adding effective amounts of one or more of salt and sodium phosphate to obtain a normalized cooked yield, wherein when the beef is heated to a desired temperature safe for human consumption the normalized cooked yield is higher than a cooked yield resulting from heating a substantially similar beef without trehalose to the same desired temperature.
